(19) United States
(12) Patent Application Publication
(10) Pub. No.: US 2024/0330011 A1
(43) Pub. Date: Oct. 3, 2024

(54) PROCESSING METHOD AND APPARATUS, DEVICE

(71) Applicant: Lenovo (Beijing) Limited, Beijing (CN)

(72) Inventors: Guangming REN, Beijing (CN); Huaqiao LI, Beijing (CN); Jing LI, Beijing (CN)

(21) Appl. No.: 18/618,277

(22) Filed: Mar. 27, 2024

(30) Foreign Application Priority Data
Mar. 31, 2023 (CN) 202310345043.2

(51) Int. Cl. G06F 9/445

(52) U.S. Cl. CPC G06F 9/445

(57) ABSTRACT

A processing method includes: obtaining a processing command issued by an application program; recognizing the processing command to obtain a recognition result; and based on the recognition result, determining a target processing unit, such that the target processing unit is able to process the processing command, the target processing unit including at least one of processing units used to form a target processing module.

### CROSS-REFERENCE TO RELATED APPLICATION

This application claims priority to Chinese Patent Application No. 202310345043.2, filed on Mar. 31, 2023, and the entire content of which is incorporated herein by reference.

### TECHNICAL FIELD

The present disclosure relates to the technical field of electronics technology, and more particularly, to a processing method, a processing apparatus, and a device.

### BACKGROUND

With the development of technology, electronic devices are widely used. As key components of electronic devices, various processing modules play an irreplaceable role in processing data.

Electronic devices require the participation of processing modules when running various applications. For example, when users use PS (Adobe Photoshop, an image processing software) software, they require the participation of the central processor and the image processor. Therefore, how to manage the resources of various processing modules based on workflow has become the focus of research by those skilled in the art.

### SUMMARY

One aspect of the present disclosure provides a processing method. The processing method includes: obtaining a processing command issued by an application program; recognizing the processing command to obtain a recognition result; and based on the recognition result, determining a target processing unit, such that the target processing unit is able to process the processing command, the target processing unit including at least one of processing units used to form a target processing module.

Another aspect of the present disclosure provides a processing apparatus. The processing apparatus includes: a memory storing a computer program and a processor coupled to the memory. When being executed by the processor, the computer program causes the processor to: obtain a processing command issued by an application program; recognize the processing command to obtain a recognition result; and based on the recognition result, determine a target processing unit, such that the target processing unit is able to process the processing command, the target processing unit including at least one of processing units used to form a target processing module.

Another aspect of the present disclosure provides an electronic device. The electronic device includes: a memory storing a computer program and a processor coupled to the memory. When being executed by the processor, the computer program causes the processor to: obtain a processing command issued by an application program; recognize the processing command to obtain a recognition result; and based on the recognition result, determine a target processing unit, such that the target processing unit is able to process the processing command, the target processing unit including at least one of processing units used to form a target processing module.

### BRIEF DESCRIPTION OF THE DRAWINGS

FIG. 1 is a flowchart of a processing method according to some embodiments of the present disclosure;

FIG. 2 is a flowchart of another processing method according to some embodiments of the present disclosure;

FIG. 3 is a flowchart of another processing method according to some embodiments of the present disclosure;

FIG. 4A is flowchart of a resource management solution according to some embodiments of the present disclosure;

FIG. 4B is flowchart of another resource management solution according to some embodiments of the present disclosure;

FIG. 4C is a flowchart of another processing method according to some embodiments of the present disclosure;

FIG. 5 is a structural diagram of a processing apparatus according to some embodiments of the present disclosure; and

FIG. 6 is a schematic diagram of a hardware implementation of an electronic device according to some embodiments of the present disclosure.

### DETAILED DESCRIPTION OF THE EMBODIMENTS

The technical solution of the present disclosure will be further described in detail below with reference to the accompanying drawings and embodiments. Obviously, the described embodiments are merely some of the embodiments of the present disclosure, but not all of the embodiments. Based on the embodiments of the present disclosure, all other embodiments obtained by those of ordinary skill in the art without any creative work shall fall within the scope of the present disclosure.

In the following description, reference is made to “some embodiments” which describe a subset of all possible embodiments, but it should be understood that “some embodiments” may be the same subset or a different subset of all possible embodiments, and may be combined with each other without conflict.

In the following description, suffixes such as “module”, “component” or “unit” used to represent elements are merely used to facilitate the description of the present disclosure and have no specific meaning in themselves. Therefore, “module”, “component” or “unit” may be used interchangeably.

It should be noted that the terms “first\second\third” involved in the embodiments of the present disclosure are merely used to distinguish similar objects and do not represent a specific ordering of objects. It should be understood that the specific order or sequence of “first\second\third”, where permitted, may be interchanged such that the embodiments of the present disclosure described herein can be practiced in an order other than that illustrated or described herein.

The present disclosure provides a processing method. The processing method may be implemented by calling a program code by a processor in an electronic device. Of course, the program code may be stored in a storage medium of the electronic device. FIG. 1 is a flowchart of a processing method according to some embodiments of the present disclosure. As shown in FIG. 1, the method includes the following processes.

At S101, a processing command issued by an application program is obtained.

The electronic device may be various types of devices with information processing capabilities, such as navigators, smartphones, tablets, wearable devices, laptop computers, all-in-one and desktop computers, server clusters, etc.

The application program (also referred to as application) refers to a computer program that completes one or more specific tasks. It runs in a user mode, interacts with users, and includes a visual user interface. Moreover, each application program runs in an independent process and has its own independent address space. Dividing lines between different applications are called process boundaries. For example, Word, Photoshop, WeChat, camera, etc. are applications running on the electronic devices. In the embodiments of the present disclosure, the application program may be any application program on the electronic device, and the application program issues corresponding processing commands during operation. For example, if the user is using a calculator application and needs to perform logical operations during use, the calculator application may issue processing commands related to logical operations. In another example, if the user is using the Photoshop application and needs to perform image rendering during use, the Photoshop application may issue processing commands related to image rendering. In another example, if the user is using the Photoshop application and needs to perform three-dimensional (3D) processing of the image during use, the Photoshop application may issue processing commands related to 3D processing. Of course, the processing command may also be understood as a task corresponding to an application program. The application program may include multiple processes while running, and each process may include multiple tasks. For example, the Photoshop application may include multiple tasks (i.e., multiple processing commands) such as two-dimensional (2D), 3D, rendering, perspective, logical OP, etc. during a running process.

It should be noted that in the embodiments of the present disclosure, attribute information such as the type of application program and the type of processing commands issued by the application program are not limited.

At S102, the processing command is recognized to obtain a recognition result.

For example, the processing command may be recognized to obtain the type of the processing command.

At S103, a corresponding target processing unit is determined based on the recognition result, such that the target processing unit can process the processing command. The target processing unit includes at least one of processing units used to form a target processing module.

The electronic device includes a plurality of processing modules, and each processing module may include a plurality of processing units. The plurality of processing units form the processing module. For example, the processing module is a central processing unit (CPU), and the multiple processing units included in the CPU may be multiple cores of the CPU, such as P-CORE (large core), E-CORE (small core), etc. In another example, the processing module is a draft graphics processing unit (DGPU, an independent graphics card). The multiple processing units included in the DGPU may be a Cuda core unit (Cuda Core), a ray tracing computing core unit (RT Core), a tensor computing core unit (Tensor Core), and a copy engine unit (Copy Engine).

In the embodiment of the present disclosure, the corresponding target processing unit may be determined based on the recognition result of the processing command, and then the target processing unit can be directly used to process the processing command. For example, if the user is using the Photoshop application and needs to perform 3D processing during use, the Photoshop application may issue a processing command related to 3D processing. After obtaining the processing command, the processor of the electronic device recognizes the processing command and obtains a recognition result. Then, the corresponding target processing unit is determined to be the ray tracing computing core unit based on the recognition result. If the ray tracing computing core unit is in a disabled state at this time, the ray tracing computing core unit is enabled, and the ray tracing computing core unit is directly called to process the obtained 3D processing command. If the ray tracing computing core unit is in an enabled state at this time, the ray tracing computing core unit is directly called to process the obtained 3D processing command. In another example, if the user is using a game application and needs to perform a large number of logical operations during use, the game application may issue a processing command related to the logical operations. After obtaining the processing command, the processor of the electronic device recognizes the processing command and obtains a recognition result. The corresponding target processing unit is determined to be the large core of the CPU based on the recognition result. Then the large core of the CPU is directly called to process the processing command related to the logical operations.

That is to say, in the prior art, the processing module is usually directly called through software, and then the processing module allocates specific processing units to execute the processing commands. The solution provided by the embodiments of the present disclosure is that the system recognizes the address of the target processing unit corresponding to the processing command based on a workflow, such that the corresponding target processing unit can be driven to respond to the processing command based on the address.

For example, in the prior art, an independent graphics card is used when a task with a heavy load is running. For example, a Photoshop application uses an independent graphics card when running. The current solution is to call the DGPU by writing the name of the corresponding software in the DGPU driver. That is, completely loading the entire DGPU through the software name. The calling method of the application program includes: through task calling (that is, processing command calling). For example, when the Photoshop application is loaded, it is processed with different tasks. At the beginning, a certain core in the CPU is called according to a first task. At this time, the DGPU is not enabled in a whitelist. If the Photoshop application subsequently needs to process large-scale graphics and needs to run in a different core unit in the DGPU (e.g., a 3D task needs to run a ray tracing computing core unit), a special function software may be used to communicate with the Photoshop application and the ray tracing computing core may be directly enabled in the DGPU, thereby increasing DGPU usage and reducing resource waste. The special function software runs on the CPU. The special function software may communicate with the application program and call the corresponding processing unit in the DGPU based on communication results. In addition, the special function software may also determine the corresponding target processing unit based on a node code reported by the application program (i.e., convert the node code into the corresponding target processing unit).

Through the above-described processing methods in processes S101 to S103, the application program and the hardware processing unit can be deeply integrated, and the required hardware core unit can be directly called, which solves the problem of lack of coordination between software and hardware support and inconsistent processing units. Thus, an end-to-end execution requirement is satisfied and hardware utilization is improved.

Based on the foregoing embodiments, the present disclosure further provides another processing method, which is applied to electronic devices. The method includes the following processes.

At S111, a processing command issued by an application program is obtained.

At S112, the processing command is recognized to obtain the type of the processing command.

Different applications include different processing commands, and different processing commands have different types. For example, if the application program is a calculator, the type of the processing command when running the application program may include a first type. The first type is used to represent that the processing command is a small-volume logical operation process. In another example, if the application is a classification application, the type of the processing command when running the application may include a second type. The second type is used to represent that the processing command is a large-volume logical operation process. In another example, if the application program is Photoshop, the type of the processing command when running the application program may include the first type, the second type, a third type, a fourth type, a fifth type, etc., where the third type is used to represent that the processing command is an all-in-one floating-point arithmetic process, the fourth type is used to represent that the processing command is a ray tracing-specific arithmetic process, and the fifth type is used to represent that the processing command is a tensor calculation process.

Of course, the type of the processing command may also include other types, and the embodiments of the present disclosure may not list them all here. It should be noted that one application program may include multiple processing commands of different types, and different application programs may also include multiple processing commands of a same type.

At S113, a corresponding target address is determined based on the type of the processing command, such that the corresponding target processing unit can be called through the target address to process the processing command. The target processing unit includes at least one of the processing units used to form the processing module.

An address of the target processing unit may be determined based on the type of the processing command. Then, the corresponding target processing unit may be called based on the address to process the processing command. That is, the solution in the embodiments of the present disclosure is to call the corresponding core unit individually and to directly access different core units through the addresses thereof. For example, a DGPU includes multiple core units, and the addresses of different core units may be provisioned in a driver. After determining the corresponding target address based on the type of the processing command, the corresponding core unit may be accessed through the address opened in the software driver.

Through the above-described processing methods in processes S111 to S113, the target address corresponding to the processing command during the running process of the application program may be determined, and then the corresponding core unit may be directly called through the target address to process the processing command of the application program, thereby effectively reducing resource waste and improving processing performance.

Based on the foregoing embodiments, the present disclosure further provides another processing method, which is applied to electronic devices. The method includes the following processes.

At S121, a corresponding node code is obtained during the running process of an application program.

The corresponding node code may be added before executing the corresponding code of the application program. For example, before executing the code corresponding to Photoshop's 3D function task, a first node code is added. Before executing the code corresponding to Photoshop's 2D function task, a second node is added. Before executing the code corresponding to Photoshop's rendering function task, a third node code is added. Before executing the code corresponding to Photoshop's perspective function task, a fourth node code is added. Before executing the code corresponding to Photoshop's logical OP function task, a fifth node code is added. That is, some Photoshop function tasks, such as rendering, 2D, 3D, encoding and decoding, image processing, etc. are configured.

In some embodiments, a special function software (LNV Al Tool) may be developed. The software may decode pre-written node codes through an Al algorithm, thereby recognizing the processing unit that the application program currently needs to call, and then driving the corresponding processing unit to perform corresponding processing. In other words, a corresponding standardized code may be formulated, such that a hardware connection node in the corresponding driver may be called when performing task operations.

At S122, the corresponding processing command is determined based on the node code and a preset mapping relationship. The preset mapping relationship includes corresponding relationships between multiple node codes and multiple processing commands.

In some embodiments, multiple mapping relationships may be included, such as a first mapping relationship between node codes and processing commands, and a second mapping relationship between processing commands and processing units. Therefore, the corresponding processing command can be determined based on the node code and the first mapping relationship. The corresponding processing unit can be determined based on the processing command and the second mapping relationship. Then, the processing unit can be directly called to achieve objectives of saving resources and improving performance.

For example, the processing command corresponding to the first node code is related to Photoshop's 3D function task, the processing command corresponding to the second node code is related to Photoshop's 2D function task, the processing command corresponding to the third node code is related to Photoshop's perspective function task, the processing command corresponding to the fourth node code is related to Photoshop's logical OP function task, the processing command corresponding to the fifth node code is related to a small-volume logical operation task, and the processing command corresponding to the sixth node code is related to a large-volume logical operation task. If the node code corresponding to the running process of the application program is obtained as the fourth node code at this time, the corresponding processing command is determined based on the first mapping relationship, and then the processing unit corresponding to the processing command is determined to be a CPU small core unit based on the second mapping relationship. Further, the small core unit is directly called according to the address of the small core unit for processing.

At S123, the processing command is recognized to obtain a recognition result.

At S124, a corresponding target processing unit is determined based on the recognition result, such that the target processing unit can process the processing command. The target processing unit includes at least one of the processing units used to form the target processing module.

In some embodiments, different processing unit addresses may be assigned to different function tasks of the application program, thereby completing the deep integration of the application program and the hardware processing unit, satisfying the end-to-end execution requirement, and improving the utilization of the hardware processing unit.

In some embodiments, the method further includes the following processes.

At 511, the application program is analyzed to determine at least one task included in the running process of the application program.

At S12, a corresponding node code for each of the at least one task is configured.

The application program may include one or more processes when being executed. Each process may include at least one task. Each task may include a node code. For example, the application program Photoshop may include 2D tasks, 3D tasks, rendering tasks, perspective tasks, logical OP tasks, etc. during the running process. The corresponding node code may be configured preceding the code corresponding to each task.

Based on the foregoing embodiments, the present disclosure further provides another processing method, which is applied to electronic devices. The method includes the following processes.

At S131, a processing command issued by an application program is obtained.

At S132, the processing command is recognized to obtain the type of the processing command.

At S133, a corresponding target address is determined based on the type of the processing command.

At S134, the processing command and the target address are written into a corresponding buffer area, such that a corresponding target processing unit can be driven to respond to the processing command based on the target address. The target processing unit includes at least one of the processing units used to form the target processing module.

After the target address is determined, the processing command and the target address may be written into the corresponding buffer area, thereby driving the processing unit corresponding to the target address to respond to the processing command. For example, based on a workflow, a system writes the processing command and a determined core address to a corresponding cache unit (such as DRAM or VRAM), and then a driver drives the corresponding core unit to respond to the processing command based on the corresponding address. In the prior art, different processing modules correspond to different drivers. In the embodiments of the present disclosure, different processing units correspond to different drivers.

Based on the foregoing embodiments, the present disclosure further provides another processing method, which is applied to electronic devices. The method includes the following processes.

At S141, a processing command issued by an application program is obtained.

At S142, the processing command is recognized to obtain the type of the processing command.

At S143, a target storage area from multiple storage areas of a storage module is determined based on the type of the processing command. Different storage areas in the multiple storage areas correspond to different processing units.

At S144, the processing command is written into the target storage area, such that the target processing unit corresponding to the target storage area can process the processing command. The target processing unit includes at least one of the processing units used to form the target processing module.

The storage module may be a memory of the electronic device, such as a double data rate double rate synchronous dynamic random-access memory (DDR RAM). In some embodiments, the storage module may be divided into multiple storage areas, and different storage areas correspond to different processing units. Further, the processing command may be written into the corresponding target storage area based on the type of the processing command. Therefore, the target processing unit corresponding to the target storage area may perform batch processing on multiple processing commands (including written processing commands) in the target storage area. In other words, the method provided by the embodiments of the present disclosure may perform collaborative processing on a multi-task (multi-processing command) instruction set. For example, if the multi-task instruction set supports more than two tasks, the multi-task instruction set may be placed in a fixed section by setting a fixed block in the memory to achieve collaborative processing of the multi-task instruction set. As such, the effectiveness of batch processing improves task processing performance. For example, a scan time of 100 ms (milliseconds) may be configured to perform batch processing without routinely calling for each program code. The target storage area may be a Cuda core register to be operated on.

In some embodiments, the processes S141 to S144 may be implemented in the following manner. A task processing mode is actively detected. When software with a special function sends a task, the number of parallel tasks (multi-tasks) is actively scanned, and parallel processing is performed to solve the problem of one-by-one task processing delay.

In some embodiments, full load processing of tasks may be performed. When the target processing unit processes the corresponding processing command, a full-hardware-on mode or an intelligent operation mode (available for user selection) may be configured through resource allocation. In the full-hardware-on mode, tasks are performed at the maximum processing performance and the corresponding hardware runs at full power. In the intelligent operation mode, the user is allowed to configure a preset power that cannot be exceeded. For example, in the full-hardware-on mode, all 64 core units of the processor are enabled. Different operation modes correspond to different states of the processing module, such as PO state of the CPU, P4 state of the CPU, etc.

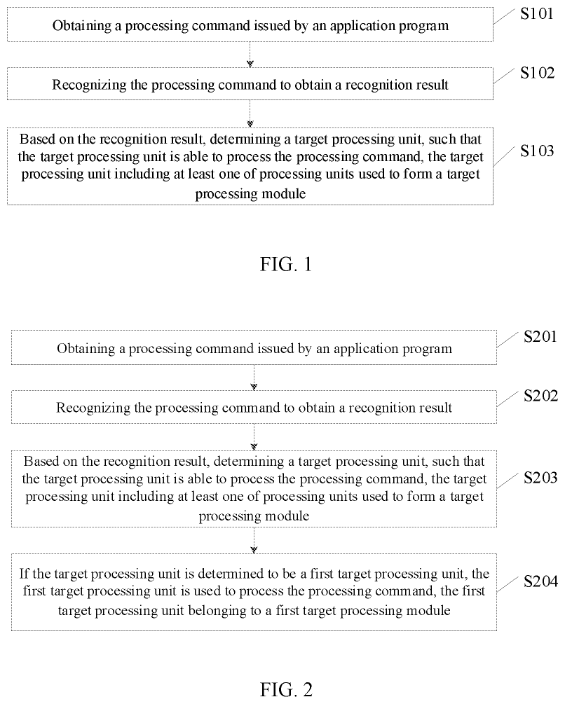

Based on the foregoing embodiments, the present disclosure further provides another processing method, which is applied to electronic devices. FIG. 2 is a flowchart of another processing method according to some embodiments of the present disclosure. As shown in FIG. 2, the method includes the following processes.

At S201: a processing command issued by an application program is obtained.

At S202, a processing command is recognized to obtain a recognition result.

At S203, a corresponding target processing unit is determined based on the recognition result, such that the target processing unit can process the processing command. The target processing unit includes at least one of the processing units used to form the target processing module.

At S204, if the target processing unit is determined to be a first target processing unit, the first target processing unit is used to process the processing command. The first target processing unit belongs to a first target processing module.

In the embodiments of the present disclosure, the first target processing module includes a central processing unit. Correspondingly, the first target processing unit includes a certain core unit in the central processing unit. Currently, Intel supports large and small core modes starting from the 12th generation CPU. High-performance P-CORE (large core unit) and low-power E-CORE (small core unit) are included inside a system on chip (SOC). Therefore, the first target processing module may be a CPU, and the first target processing unit may be a large core unit in the CPU or a small core unit in the CPU. Of course, if the CPU includes multiple large cores and multiple small cores, the first target processing unit may be a certain large core unit among the multiple large core units, or a certain small core unit among the multiple small core units. Further, CPUs may include more types of core units, such as large core units, medium core units, and small core units. Then the first target processing unit may be a large core unit, a small core unit, or a medium core unit.

Through the above-described processing methods in processes S201 to S204, the application program may be deeply integrated with different core units of the CPU, and the required core units may be directly called, which solves the problem of lack of coordination between software and hardware support and inconsistent processing units. Thus, the end-to-end execution requirement is satisfied and CPU utilization is improved.

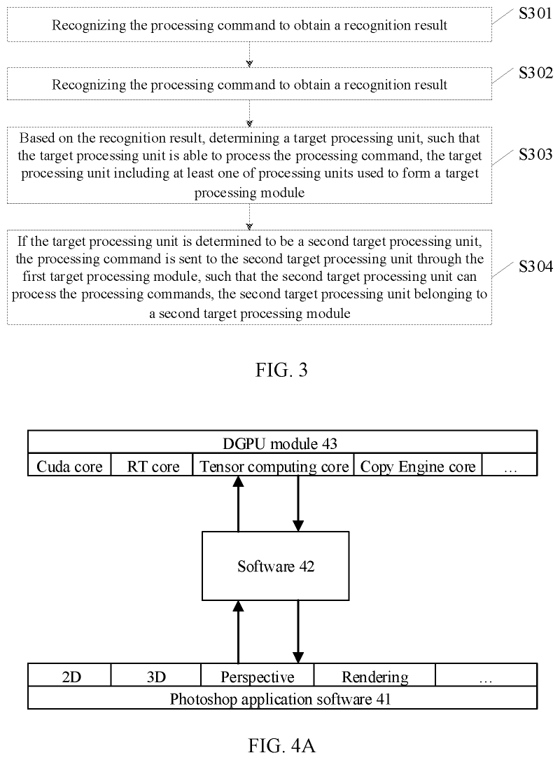

Based on the foregoing embodiments, the present disclosure further provides another processing method, which is applied to electronic devices. FIG. 3 is a flowchart of another processing method according to some embodiments of the present disclosure. As shown in FIG. 3, the method includes the following processes.

At S301, a processing command issued by an application program is obtained.

At S302, a processing command is recognized to obtain a recognition result.

At S303, a corresponding target processing unit is determined based on the recognition result, such that the target processing unit can process the processing command. The target processing unit includes at least one of the processing units used to form the target processing module.

At S304, if the target processing unit is determined to be a second target processing unit, the processing command is sent to the second target processing unit through the first target processing module, such that the second target processing unit can process the processing commands. The second target processing unit belongs to a second target processing module.

In some embodiments, the first target processing module includes a central processing unit, and the second target processing module includes a graphics processing unit, such as an integrated graphics card or a discrete graphics card. Correspondingly, the second target processing unit includes a certain core unit in the graphics processing unit. The core units of the graphics processing unit include but are not limited to: Cuda core unit, ray tracing operation core unit, tensor calculation core unit, and copy engine core unit. Further, if the target processing unit is determined to be one of the above-described core units, the CPU sends the obtained processing command to the core unit, such that the core unit can process the processing command. That is, the processing module of the electronic device in the embodiments of the present disclosure at least includes a CPU and a GPU. If it is determined that a certain core unit in the CPU needs to be called based on the recognition result, the core unit in the CPU may perform the processing. If it is determined that a certain core unit in the GPU needs to be called, the processing command is forwarded by the CPU to the GPU, and then processed by the core unit in the GPU.

Of course, the first target processing module can be a processing module other than the CPU, and the second target processing module can also be a processing module other than the GPU. This is not limited in the embodiments of the present disclosure.

Through the above-described processing methods in processes S301 to S304, the application program may be deeply integrated with different core units of the CPU, and the required core units may be directly called, which solves the problem of lack of coordination between software and hardware support and inconsistent processing units. Thus, the end-to-end execution requirement is satisfied and CPU utilization is improved.

In some embodiments, the electronic device may also include a middleware (software) that communicates with the application program and call the corresponding processing unit in the processing module based on communication results. For example, the electronic device runs Photoshop software. The middleware may determine the corresponding processing unit based on the node code currently running on the Photoshop software (i.e., the node code corresponding to the currently running task), and may then decide whether to allocate the task to a certain processing unit in the DGPU or the CPU for processing (or a certain core unit in the CPU for processing). The middleware runs on the CPU. If multiple tasks need to access the same core unit at the same time, a queue process is used.

Based on the foregoing embodiments, the present disclosure further provides another processing method, which is a solution for calling DGPU and CPU resources based on workflow. This solution can solve a problem in the current method that independent graphics cards are called based on a pre-defined APP (application program) list and DGPU or CPU resources cannot be used if the software that needs to call DGPU or CPU is not included in the pre-defined AP list.

The solution generally includes the following processes. Through in-depth cooperation with CPU and GPU manufacturers, code ports are open as calling ports for a software process provided in the embodiments of the present disclosure, such that program codes and the workflow can be substantially integrated and graphics card kernel can be called to operate efficiently. The advantages of adopting this solution includes the following. Through software development to support the code ports, application software and graphics card hardware are substantially integrated. The graphics card kernel that needs to be called can be called timely. Thus, the problems of lack of coordination between software and hardware support and inconsistent processing units is solved, the end-to-end execution requirement is satisfied, and the graphics card utilization is improved.

In the embodiments of the present disclosure, through a bridging function of Al Tool APP (a software with special function), the application software is able to be directly connect to a unit module that the corresponding GPU needs to process, the processing efficiency of the processing unit is improved, response time to users of the application software is shortened, and customer experience and satisfaction are improved. The solution (i.e. processing method) is described in detail below.

In some embodiments, a check point is added before the application software executes the corresponding program code. For example, when executing the 3D function in Adobe Photoshop, the Cuda core unit in GDPU is called. With the help of an application programming interface (API), various modules work together to successfully complete various calling functions.

In some embodiments, vendors of application software (such as Photoshop), DGPU, and electronic devices jointly formulate a corresponding standardized program code, such that tasks can be performed through calling hardware connection nodes in corresponding drivers.

In some embodiments, when the application software is used by application engineers, LNV Al Tool may define complete node codes written in advance based on types of the application software. Artificial intelligence (AI) algorithms may be used to process the node codes and a result is provided to CPU and DGPU drivers. Corresponding function units of CPU or DGPU are driven to perform corresponding processing, thereby achieving the objective of optimized and rational use of hardware resources. The special function software LNV Al Tool runs on CPU.

For example, the application software may be CINEMA 4D application software, Cutout application software, Maya application software, Photoshop application software, WeChat, etc. Further, based on the three-party alliance of the vendors of application software, CPU and GPU, and electronic devices, a high-efficiency low-energy consumption solution can be achieved.

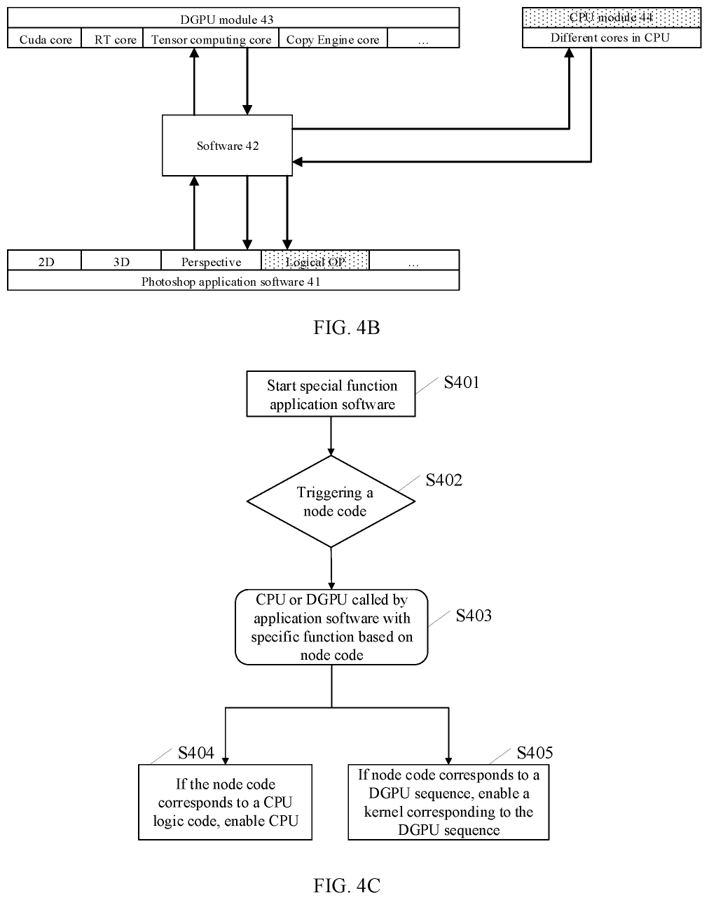

FIG. 4A is flowchart of a resource management solution according to some embodiments of the present disclosure. As shown in FIG. 4A, Photoshop application software 41 includes multiple function tasks during operation: 2D, 3D, perspective and rendering, etc. LNV Al Tool software 42 obtains the node code of Photoshop application software 41 at the current running time (different node codes correspond to different function tasks), decodes the node code to obtain DGPU kernel corresponding to the node code, and directly calls DGPU kernel for processing the function task corresponding to the node code. DGPU module 43 includes a Cuda core unit (all-purpose floating-point computing unit), an RT core unit (ray tracing computing core unit), a Tensor core unit (tensor computing core unit), a Copy Engine core unit (copy engine unit), etc.

FIG. 4B is flowchart of another resource management solution according to some embodiments of the present disclosure. As shown in FIG. 4B, Photoshop application software 41 includes multiple function tasks during operation: 2D, 3D, perspective and logical OP, etc. LNV Al Tool software 42 obtains the node code of Photoshop application software 41 at the current running time (different node codes correspond to different function tasks), decodes the node code to obtain DGPU kernel corresponding to the node code, and directly calls DGPU kernel for processing the function task corresponding to the node code. DGPU module 43 includes a Cuda core unit (all-purpose floating-point computing unit), an RT core unit (ray tracing computing core unit), a Tensor core unit (tensor computing core unit), a Copy Engine core unit (copy engine unit), etc. Function tasks such as 2D, 3D, and perspective correspond to different kernels in DGPU module 43. At the same time, if Photoshop application software 41 is running a logical OP function task at this time, LNV Al Tool software 42 obtains the node code of Photoshop application software 41 at the current running time (i.e., the node code corresponding to the logical OP), decodes the node code to obtain that the core unit corresponding to the node code as CPU module 44, and directly calls CPU module 44 to process the logical OP function task corresponding to the node code.

FIG. 4C is a flowchart of another processing method according to some embodiments of the present disclosure. As shown in FIG. 4C, the processing method includes the following processes.

At S401, an application software with a special function is started.

At S402, a node code is triggered by the application software.

At S403, corresponding CPU or DGPU is called by the application software with the specific function based on the node code;

At S404, if the node code corresponds to a CPU logic code, CPU is enabled.

At S405, if the node code corresponds to a DGPU sequence, a kernel corresponding to the DGPU sequence is enabled.

In other words, the operation of DGPU is currently enabled through a whitelist (i.e. Enable DGPU), without distinguishing specific tasks of an actual workflow, which affects the time and power consumption of normal use, resulting in a waste of resources. In some embodiments, after the special function software LNV Al Tool is introduced, both CPU and DGPU may reasonably allocate resources, thereby filling a technical gap and effectively improving performance.

Based on the foregoing embodiments, the present disclosure provides a processing apparatus, which includes various units, various modules included in each unit, and various components included in each module. The processing apparatus may be a processor in an electronic device or a specific logic circuit. During the implementation process, the processor may be a central processing unit (CPU), a microprocessor unit (MPU), a digital signal processing (DSP), or a field programmable gate array (FPGA), etc.

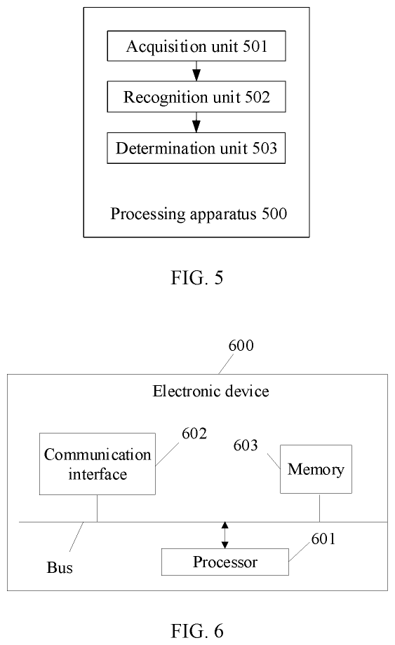

FIG. 5 is a structural diagram of a processing apparatus according to some embodiments of the present disclosure. As shown in FIG. 5, the processing apparatus 500 includes: an acquisition unit 501 configured to obtain a processing command issued by an application program, a recognition unit 502 configured to recognize the processing command to obtain a recognition result, and a determination unit 503 configured to determine a corresponding target processing unit based on the recognition result, such that the target processing unit can process the processing command. The target processing unit includes at least one of the processing units used to form the target processing module.

In some embodiments, the target processing module includes a first target processing module. Correspondingly, the processing apparatus also includes a first processing unit configured to use a first target processing unit to process the processing command if the target processing unit is determined to be a first target processing unit. The first target processing unit belongs to the first target processing module.

In some embodiments, the target processing module includes a first target processing module and a second target processing module. Correspondingly, the processing apparatus also includes a second processing unit configured to send the processing command to the second target processing unit through the first target processing module if the target processing unit is determined to be a second target processing unit, such that the second target processing unit is capable of processing the processing command. The second target processing unit belongs to the second target processing module.

In some embodiments, the recognition result includes the type of the processing command. Correspondingly, the determination unit 503 includes a first determination subunit configured to determine a corresponding target address based on the type of the processing command, such that the corresponding target processing unit can be called through the target address to process the processing command.

In some embodiments, the first determination subunit includes an address determination module configured to determine a corresponding target address based on the type of the processing command, a writing module configured to write the processing command and the target address into a corresponding buffer area, such that the corresponding target processing unit can be driven to respond to the processing command based on the target address.

In some embodiments, the recognition result includes the type of the processing command. Correspondingly, the determination unit 503 includes a second determination subunit configured to determine a target storage area from multiple storage areas of a storage module based on the type of the processing command. Different storage areas in the multiple storage areas correspond to different processing units. The second determination subunit is also configured to write the processing command into the target storage area, such that a target processing unit corresponding to the target storage area can process the processing command.

In some embodiments, the acquisition unit 501 includes a node code acquisition module configured to obtain a corresponding node code during the running process of the application program and a processing command determination module configured to determine a corresponding processing command based on the node code and a preset mapping relationship. The preset mapping relationship includes corresponding relationships between multiple node codes and multiple processing commands.

In some embodiments, the processing apparatus further includes an analysis unit configured to analyze the application program and determine at least one task included in the running process of the application program and a configuration unit configured to configure a corresponding node code for each of the at least one task.

The description of the processing apparatus embodiments is similar to the description of the processing method embodiments, and has similar beneficial effects as the processing method embodiments. For technical details not disclosed in the processing apparatus embodiments of the present disclosure, reference can be made to the description of the processing method embodiments of the present disclosure for understanding.

It should be noted that in the embodiments of the present disclosure, if the above-described processing method is implemented in the form of a software function module and sold or used as an independent product, it may also be stored in a computer-readable storage medium. Based on this understanding, the technical solutions of the embodiments of the present disclosure may be embodied in the form of computer software products in essence or those that contribute to the existing technology. The computer software products are stored in the computer-readable storage medium and include a plurality of instructions. When being executed by an electronic device (which may be a personal computer, a server, etc.), the plurality of instructions cause the electronic device to execute all or part of the processing method described in various embodiments of the present disclosure. The storage medium includes: a U disk, a mobile hard disk, a read-only memory (ROM), a magnetic disk or an optical disk, and other media that can store program codes. As such, the embodiments of the present disclosure are not limited to any specific combination of hardware and software.

Correspondingly, the present disclosure provides an electronic device, including a memory and a processor. The memory stores a computer program that can be run on the processor. When the processor executes the program, it implements the processing method provided in the embodiments of the present disclosure.

Correspondingly, the present disclosure provides a computer-readable storage medium on which a computer program is stored. When the computer program is executed by a processor, the processing method is implemented.

It should be noted that the description of the storage medium and the processing apparatus embodiments is similar to the description of the processing method embodiments, and has similar beneficial effects as the processing method embodiments. For technical details not disclosed in the storage medium and the processing apparatus embodiments of the present disclosure, reference can be made to the description of the processing method embodiments of the present disclosure for understanding.

FIG. 6 is a schematic diagram of a hardware implementation of an electronic device 600 according to some embodiments of the present disclosure. As shown in FIG. 6, the electronic device 600 includes: a processor 601, a communication interface 602, and a memory 603. The processor 601 generally controls the overall operation of the electronic device 600.

The communication interface 602 may enable the electronic device 600 to communicate with other electronic devices or servers or platforms over a network.

The memory 603 is configured to store instructions and applications executable by the processor 601, and to also cache data to be processed or already processed by the processor 601 and each module in the electronic device 600 (e.g., image data, audio data, voice communication data, and video communication data). The memory 603 may be a flash memory or a random-access memory (RAM).

In the embodiments of the present disclosure, it should be understood that the disclosed processing apparatus and processing method may be implemented in other ways. The processing apparatus embodiments described above are merely illustrative. For example, division of units is merely a logical function division. In actual implementation, there may be other division methods, such as: multiple units or components may be combined, or can be integrated into another system, or some features can be ignored, or not implemented. In addition, coupling, direct coupling, or communication connection between the components shown or discussed may be through some interfaces, and indirect coupling or communication connection of the devices or units may be electrical, mechanical, or other forms.

The units described above as separate components may or may not be physically separated. The components shown as units may or may not be physical units, that is, they may be located in one place or distributed to multiple network units. Some or all of the units can be selected according to actual needs to achieve the objective of the solution of the present disclosure.

In addition, each function unit in each embodiment of the present disclosure may be all integrated into one processing module, or each function unit may be separately used as one function unit, or two or more function units may be integrated into one function unit. The above-described integrated unit may be implemented in the form of hardware or in the form of hardware plus software function units. Those of ordinary skill in the art should understand that all or part of the processes to implement the processing method embodiments may be completed by hardware related to program instructions. The program instructions may be stored in a computer-readable storage medium. When the program instructions are executed, the program instructions include the processes of the processing method embodiments. The storage medium includes various media that can store program codes, such as mobile storage devices, ROM, RAM, magnetic disks or optical disks.

The processing methods disclosed in various processing method embodiments provided in the present disclosure may be combined arbitrarily to obtain new processing method embodiments without conflict.

The features disclosed in the embodiments of the present disclosure may be combined arbitrarily without conflict to obtain new embodiments.

The features disclosed in the processing method embodiments or in the processing apparatus embodiments provided in the present disclosure may be combined arbitrarily without conflict to obtain new processing method embodiments or new processing apparatus embodiments.

The above are merely some embodiments of the present disclosure, but the scope of the present disclosure is not limited thereto. Any person familiar with the technical field can easily think of changes or substitutions within the technical scope disclosed in the present disclosure, which should be covered by the scope of the present disclosure. Therefore, the scope of the present disclosure should be subject to the scope defined by the appended claims.

What is claimed is:

1. A processing method, comprising:
obtaining a processing command issued by an application program;
recognizing the processing command to obtain a recognition result; and
based on the recognition result, determining a target processing unit, such that the target processing unit is able to process the processing command, the target processing unit including at least one of processing units used to form a target processing module.

2. The method according to claim 1, wherein:
the target processing module includes a first target processing module; and
the processing method further includes: in response to the target processing unit being determined to be a first target processing unit, using the first target processing unit to process the processing command, the first target processing unit belonging to the first target processing module.

3. The method according to claim 1, wherein:
the target processing module includes a first target processing module and a second target processing module; and
the processing method further includes: in response to the target processing unit being determined to be a second target processing unit, sending the processing command to the second target processing unit through the first target processing module, such that the second target processing unit is able to process the processing command, the second target processing unit belonging to the second target processing module.

4. The method according to claim 1, wherein:
the recognition result includes a type of the processing command; and
determining the target processing unit based on the recognition result includes: determining a target address based on the type of the processing command, such that the target processing unit is called through the target address to process the processing command.

5. The method according to claim 4, wherein determining the target address based on the type of the processing command, such that the target processing unit is called through the target address to process the processing command comprises:
based on the type of the processing command, determining the target address; and
writing the processing command and the target address into a buffer area, such that the target processing unit is driven based on the target address to respond to the processing command.

6. The method according to claim 1, wherein:
the recognition result includes a type of the processing command; and
determining the target processing unit based on the recognition result includes:
based on the type of the processing command, determining a target storage area from multiple storage areas on a storage module, different storage areas from the multiple storage areas correspond to different processing units; and
writing the processing command into the target storage area, such that the target processing unit corresponding to the target storage area is able to process the processing command.

7. The method according to claim 1, wherein obtaining the processing command issued by the application program comprises:
obtaining a node code during a running process of an application program; and
based on the node code and a preset mapping relationship, determining the processing command, the preset mapping relationship including mapping relationships between multiple node codes and multiple processing commands.

8. The method according to claim 7, further comprising:
analyzing the application program to determine at least one task during a running process of the application program; and
configuring one node code corresponding to each task of the at least one task.

9. A processing apparatus, comprising a memory storing a computer program and a processor coupled to the memory, when being executed by the processor, the computer program causing the processor to:
obtain a processing command issued by an application program;
recognize the processing command to obtain a recognition result; and
based on the recognition result, determine a target processing unit, such that the target processing unit is able to process the processing command, the target processing unit including at least one of processing units used to form a target processing module.

10. The apparatus according to claim 9, wherein:
the target processing module includes a first target processing module; and
the processor is further configured to: in response to the target processing unit being determined to be a first target processing unit, use the first target processing unit to process the processing command, the first target processing unit belonging to the first target processing module.

11. The apparatus according to claim 9, wherein:
the target processing module includes a first target processing module and a second target processing module; and
the processor is further configured to: in response to the target processing unit being determined to be a second target processing unit, send the processing command to the second target processing unit through the first target processing module, such that the second target processing unit is able to process the processing command, the second target processing unit belonging to the second target processing module.

12. The apparatus according to claim 9, wherein:
the recognition result includes a type of the processing command; and
correspondingly, when determining the target processing unit based on the recognition result, the processor is further configured to: determine a target address based on the type of the processing command, such that the target processing unit is called through the target address to process the processing command.

13. The apparatus according to claim 12, wherein when determining the target address based on the type of the processing command, such that the target processing unit is called through the target address to process the processing command, the processor is further configured to:
based on the type of the processing command, determine the target address; and
write the processing command and the target address into a buffer area, such that the target processing unit is driven based on the target address to respond to the processing command.

14. The apparatus according to claim 9, wherein:
the recognition result includes a type of the processing command; and
when determining the target processing unit based on the recognition result, the processor is further configured to:
based on the type of the processing command, determine a target storage area from multiple storage areas on a storage module, different storage areas from the multiple storage areas correspond to different processing units; and
write the processing command into the target storage area, such that the target processing unit corresponding to the target storage area is able to process the processing command.

15. The apparatus according to claim 9, wherein when obtaining the processing command issued by the application program, the processor is further configured to:
obtain a node code during a running process of an application program; and
based on the node code and a preset mapping relationship, determine the processing command, the preset mapping relationship including mapping relationships between multiple node codes and multiple processing commands.

16. The apparatus according to claim 15, wherein the processor is further configured to:
analyze the application program to determine at least one task during a running process of the application program; and
configure one node code corresponding to each task of the at least one task.

17. An electronic device, comprising a memory storing a computer program and a processor coupled to the memory, when being executed by the processor, the computer program causing the processor to:
obtain a processing command issued by an application program;
recognize the processing command to obtain a recognition result; and
based on the recognition result, determine a target processing unit, such that the target processing unit is able to process the processing command, the target processing unit including at least one of processing units used to form a target processing module.

18. The electronic device according to claim 17, wherein:
the target processing module includes a first target processing module; and
the processor is further configured to: in response to the target processing unit being determined to be a first target processing unit, use the first target processing unit to process the processing command, the first target processing unit belonging to the first target processing module.

19. The electronic device according to claim 17, wherein:
the target processing module includes a first target processing module and a second target processing module; and
the processor is further configured to: in response to the target processing unit being determined to be a second target processing unit, send the processing command to the second target processing unit through the first target processing module, such that the second target processing unit is able to process the processing command, the second target processing unit belonging to the second target processing module.

20. The electronic device according to claim 17, wherein:
the recognition result includes a type of the processing command; and
when determining the target processing unit based on the recognition result, the processor is further configured to: determine a target address based on the type of the processing command, such that the target processing unit is called through the target address to process the processing command.
